(19) United States
(12) Patent Application Publication
(10) Pub. No.: US 2024/0351455 A1
(43) Pub. Date: Oct. 24, 2024

(54) Wireless Communication Setup for Wireless Power Transfer for Electric Vehicles

(71) Applicant: WiTricity Corporation, Watertown, MA (US)

(72) Inventor: Roman Heinrich, Lenzburg (CH)

(73) Assignee: WiTricity Corporation, Watertown, MA (US)

(21) Appl. No.: 18/640,289

(22) Filed: Apr. 19, 2024

Related U.S. Application Data
(60) Provisional application No. 63/589,501, filed on Oct. 11, 2023.
(60) Provisional application No. 63/497,402, filed on Apr. 20, 2023.

(51) Int. Cl. B60L 53/126; B60L 53/30

(52) U.S. Cl. CPC B60L 53/126; B60L 53/305

(57) ABSTRACT

A method for pairing a vehicle to a wireless power transfer (WPT) station and determining their relative location using ultra-wideband (UWB) signaling is described. A Master UWB Tag transmits a Ping message and a Master UWB Anchor transmits a Pong message. The Master Tag and Master Anchor use single-sided two-way ranging (SS-TWR) or double-sided two-way ranging (DS-TWR) to determine the distance between them. The Master Tag and the Master Anchor exchange setup parameters to establish communication between the vehicle and the WPT station and determine their relative position. Each UWB tag and each UWB anchor in the WPT station determine a distance between each tag and each anchor. Based on the distances between tags and anchors and data describing the position of each anchor within the WPT station, a relative position of the vehicle and the WPT station is determined.

### RELATED APPLICATIONS

This present disclosure is related to U.S. Pat. Nos. 10,343,535 and 11,452,028, and U.S. Patent Application Publication No. 2023-0010102, and claims the benefit of U.S. Provisional Patent Application No. 63/589,501, filed on Oct. 11, 2023, and U.S. Provisional Patent Application No. 63/497,402, filed on Apr. 20, 2023, the disclosures of which are incorporated by reference herein in their entirety.

### BACKGROUND

This application relates to wireless communication setup and, in particular, to establishing communications between an electric vehicle and a wireless power transfer station.

Wireless power transfer (WPT) for charging electric vehicles is described in detail in patents such as U.S. Pat. No. 8,933,594, titled “Wireless energy transfer for vehicles,” and 9,561,730, titled “Wireless power transmission in electric vehicles,” which are incorporated here by reference in their entirety. One aspect of wireless power transfer for electric vehicle charging to be addressed is establishing communications between the vehicle and the WPT station at which the vehicle is parked. This establishment of communications can be particularly difficult in a facility with multiple WPT stations, at which multiple vehicles may be attempting to park at the same time. It is necessary to disambiguate the connections—that is, make sure that each vehicle is actually in communication with the WPT station it is attempting to use and not another nearby station. Electric vehicles that plug in to power transfer stations may also use wireless communication for connection-related communications, in which case they have the same need for assuring that they are in wireless communication with the same station to which they are connected by wire.

### SUMMARY

A vehicle having a plurality of ultra-wideband (UWB) tags is paired to a wireless power transfer (WPT) station having a first plurality of UWB anchors. A Master Tag of the plurality of UWB tags transmits a first Ping message. A Master Anchor of the first plurality of UWB anchors receives the first Ping message and transmits a first Pong message. The Master Tag receives the first Pong message and transmits a first Poll message. The Master Anchor receives the first Poll message and transmits a first Response message. Based on the first Response message, a distance between the Master Tag and the Master Anchor is determined, and setup parameters are communicated between the Master Tag and the Master Anchor to establish ongoing communications between the vehicle and the WPT station.

Implementations may include one or more of the following, in any order or combination. The setup parameters may comprise a sync-code randomly selected from a list of existing sync-codes by the Master Tag. The setup parameters may comprise a station-to-station (STS)-Key generated by the Master Anchor. The Master Anchor may transmit the first Pong message at a randomly determined time slot. The Poll message and the Response message(s) may be used to determine the distance using a single-sided two-way ranging (SS-TWR) process. The Poll message and the Response message(s) may be used to determine the distance using a double-sided two-way ranging (DS-TWR) process. An updated relative position between the vehicle and the WPT station may be continuously determined. The setup parameters may include information describing the position of each UWB anchor within the WPT station, and continuously determining the updated relative position may include interleaving double-sided two-way ranging (DS-TWR) messages between each UWB tag of the plurality of tags and each UWB anchor within the station based on the DS-TWR messages, determining the distance between each UWB tag and each UWB anchor, and, based on the determined distances between the UWB tags and the UWB anchors and the position of each UWB anchor within the WPT station, determining the relative position of the vehicle with respect to the WPT station.

Establishing ongoing communications between the vehicle and the WPT station may comprise joining a Wi-Fi transceiver of the vehicle to a Wi-Fi network with which the WPT station is also in communication. Establishing ongoing communications between the vehicle and the WPT station may comprise establishing a persistent data connection between the plurality of UWB tags and the first plurality of UWB anchors.

A second Master Anchor transceiver of a second plurality of UWB anchors at a second WPT station may receive the first Ping message and transmit a second Pong message. The Master Tag, receiving the second Pong message, may transmit a second Poll message. The second Master Anchor, receiving the second Poll message, may transmit a second Response message. Based on the first Response message and second Response message, whichever of the first and second WPT stations is closer to the vehicle is selected. Communicating setup parameters between the Master Tag and the Master Anchor includes communicating the setup parameters between the Master Tag and the Master Anchor of the selected WPT station to establish ongoing communications between the vehicle and the selected WPT station.

### BRIEF DESCRIPTION OF THE DRAWINGS

FIG. 1 illustrates an example electric vehicle charging environment including a parking facility with multiple wireless power transfer stations for use by electric vehicles.

FIG. 2 illustrates a vehicle and a wireless power transfer station implementing an ultra-wideband position determination system.

FIG. 3 illustrates an example of an electric vehicle wireless power transfer facility using an ultra-wideband communication system.

FIGS. 4 and 5A-5D illustrate processes for establishing communications between an electric vehicle and a wireless power transfer station.

FIGS. 6A-6D and 7 illustrate message flows between transponders.

FIG. 8 illustrates a block diagram of a communications system within a wireless power transfer system.

FIG. 9-12 illustrate other example processes for establishing communications between an electric vehicle and a wireless power transfer station.

### DETAILED DESCRIPTION

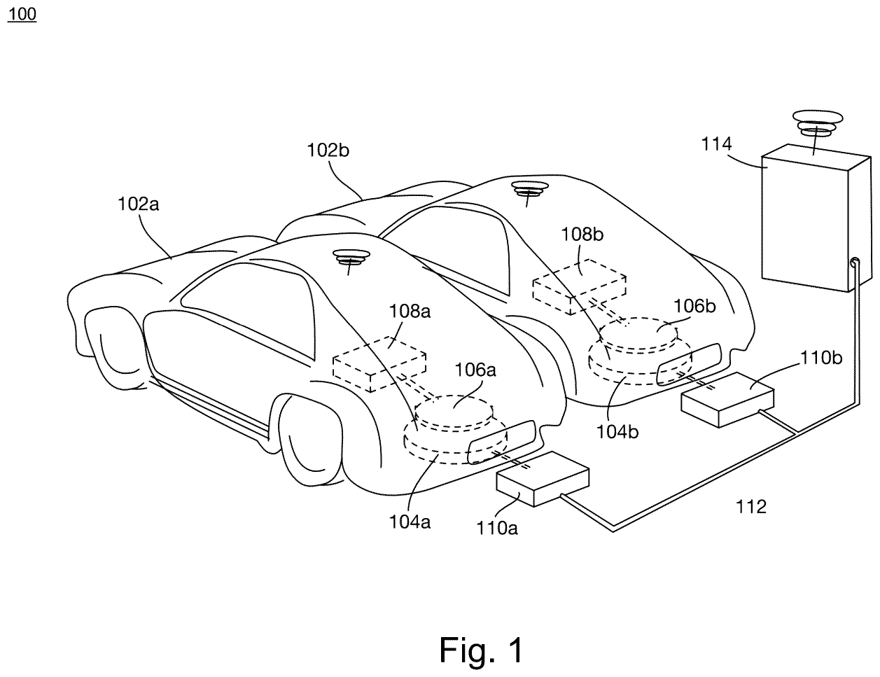

FIG. 1 shows an example of a parking facility 100 with wireless power transfer (WPT) services, which may include grid-to-vehicle (G2V) WPT operation (e.g., for charging a traction battery of the vehicle), vehicle-to-grid (V2G) WPT operation (e.g., for discharging the battery and feeding energy back to the grid), vehicle-to-home (V2H) operation, or a similar arrangement (generally V2x or x2V). Two vehicles 102a, 102b are each parked over a ground-based WPT pad 104a, 104b (e.g., WPT transmitters). Vehicle-based WPT pads 106a, 106b (e.g., WPT receivers) are connected to respective power converters 108a, 108b. In the x2V operation, the power converters 108a, 108b convert power received by the vehicle-based WPT pads 106a, 106b to a form suitable for charging the vehicle's traction battery, not shown. In some examples, the power converters 108a, 108b may be integrated with power converters used for plug-in charging of the vehicle, commonly called on-board chargers (OBC), or other on-board vehicle components. The ground-based WPT pads 104a, 104b are shown connected to power converters 110a, 110b, each connected to a power supply bus 112. The power supply bus 112 is in turn connected to a central power distribution unit 114. In some examples, the ground-based equipment including the WPT pad and power converter (e.g., WPT pad 104a and power converter 110a) and any other ground-side electronics is referred to as ground assembly (GA) or as a WPT station. Similarly, the vehicle-based equipment including the WPT pad and power converter (e.g., WPT pad 106a and power converter 108a) may be referred to as a Vehicle Assembly (VA). More generally, GA and VA may refer to the complete WPT system external to, and internal to, the vehicle, respectively.

In some examples of power transfer to the vehicle 102a (x2V operation), the central power distribution unit 114 provides direct current (DC) power to the power supply bus 112, and the power converter 110a acts as an inverter, such as the multi-level inverter described in provisional U.S. Application 63/379,537, filed Oct. 14, 2022, and incorporated here by reference. The inverter provides a low-frequency (LF) power signal with a frequency, for example, in the range 79 to 90 kHz, as specified by the SAE J2954 standard, to the ground-based WPT pad 104a, to turn into an LF magnetic field for wirelessly transferring power to the vehicle-based WPT pad 106a. The power converter 108a acts as a rectifier to turn the LF power received by the WPT pad 106a into DC power that is finally fed into the traction battery of the vehicle 102a. In other examples, the central power distribution unit 114 provides the LF signals directly to each WPT pad, and the power converters 110a, 110b are simpler or not present. In yet other examples, the central power distribution unit 114 and the power supply bus 112 are not present, and the power converters 110a, 110b are each connected directly to a power utility (not shown) and convert alternating current (AC) power from the utility to LF power for WPT.

In some examples of V2x operation, in which the parking facility 100 supports bidirectional services, the traction battery of the vehicle 102b provides DC power to the power converter 108b, which acts as an inverter to provide an LF power signal with a frequency, e.g., in the range 79 to 90 kHz, to the WPT pad 106b to turn into an LF magnetic field for wirelessly transferring power to the ground-based WPT pad 106b. Correspondingly, the power converter 110B and the power distribution unit 114 operate in a reverse mode providing power to the grid or to any other electric load.

The WPT pads 104a, 104b, 106a, and 106b each include a coil suitably configured to inductively transfer power over the air gap between the ground-based pad and the vehicle-based pad. In some implementations, each of the WPT pads 104a, 104b, 106a, and 106b additionally includes components forming a resonator in combination with the coil. The WPT pads 104a, 104b, 106a, and 106b are referred to as Ground Assembly Resonators (GAR) and Vehicle Assembly Resonators (VAR), respectively.

In some examples, the WPT pads 104a, 104b, 106a, 106b may integrate devices, sensors, and antennas for ancillary functions such as communications, foreign object detection (FOD) and living object detection (LOD) used for purposes of safety of equipment and persons, and vehicle detection (VD) and position determination (PD) used for vehicle guidance and alignment. In some implementations, some or all devices, sensors, and antennas may be external to the WPT pads 104a, 104b, 106a, 106b and may be disposed at suitable locations in the parking spot and on the vehicle, respectively.

WPT to or from electric vehicles requires communication between the WPT system of the vehicle (referred to herein as the VA) and the ground-based WPT system providing the GA pad over which the vehicle is (or intends to be) parked. Note that this discussion assumes each GA pad is part of a single ground-based WPT system (a GA) with which the vehicle communicates. In some examples, components other than the GA pad are shared between multiple GA pads; the VA communication with such a shared system nonetheless depends on which GA pad the vehicle is or intends to be parked over, and such communications are referred to as being between the VA (or vehicle) and the GA without limiting the specific configuration of the GA. Some WPT systems, such as those implementing SAE J2954, use Wi-Fi for this communication. In parking lots with multiple GAs, it is necessary to assure that a vehicle is actually communicating with the GA at which it is parked and not another nearby GA. A vehicle may establish network communications with a GA in an adjacent parking spot, falsely determining that it has established communication with the correct GA in its own parking spot. When the vehicle requests power and does not receive it (because it is in communication with the wrong GA), the vehicle may not detect the source of the problem. Likewise, the GA in the adjacent parking spot may detect a fault because it is providing power and recognizes no load. This problem may be referred to as “cross-connect.” In addition to the primary function of providing power being compromised in a cross-connect situation, some ancillary functions (e.g., PD, FOD, and LOD) may not operate properly, if at all, when communications are not established between the VA and the correct GA.

If each individual GA has its own Wi-Fi access point providing its own Wi-Fi network SSID (service set identifier), assuring that the vehicle using a given GA is paired to the Wi-Fi network provided by that GA may be difficult-U.S. Pat. No. 11,452,028, mentioned above, provides one such solution to that problem, using beacon signals generated by the vehicle and detected by the FOD system of the GA for vehicle PD to also confirm the vehicle's identity to the GA. Using only the site Wi-Fi, and not separate Wi-Fi networks per the GA, also requires some method of confirming that the vehicle is parked over the correct GA. U.S. Pat. No. 10,343,535, also mentioned above, describes, among other magnetic field-based techniques, using ultra-wideband (UWB) signals for determining vehicle position. U.S. Pat. Nos. 9,772,401 and 10,139,238 also describe using UWB signals for vehicle positioning. In some examples, the beacon signals described in the 11,452,028 patent may not have the range or bandwidth to be used for vehicle-to-GA disambiguation, but UWB signals may. In such examples, described in more detail below, UWB transceivers in the GA and in the VA may be used at least to identify the vehicle to the GA and assure correct pairing. In further examples, the UWB transceivers may be used for the charging-session control communications, avoiding the need to join the vehicle to Wi-Fi associated with the GA, or even the site, in the first place.

### UWB-Based Position Determination

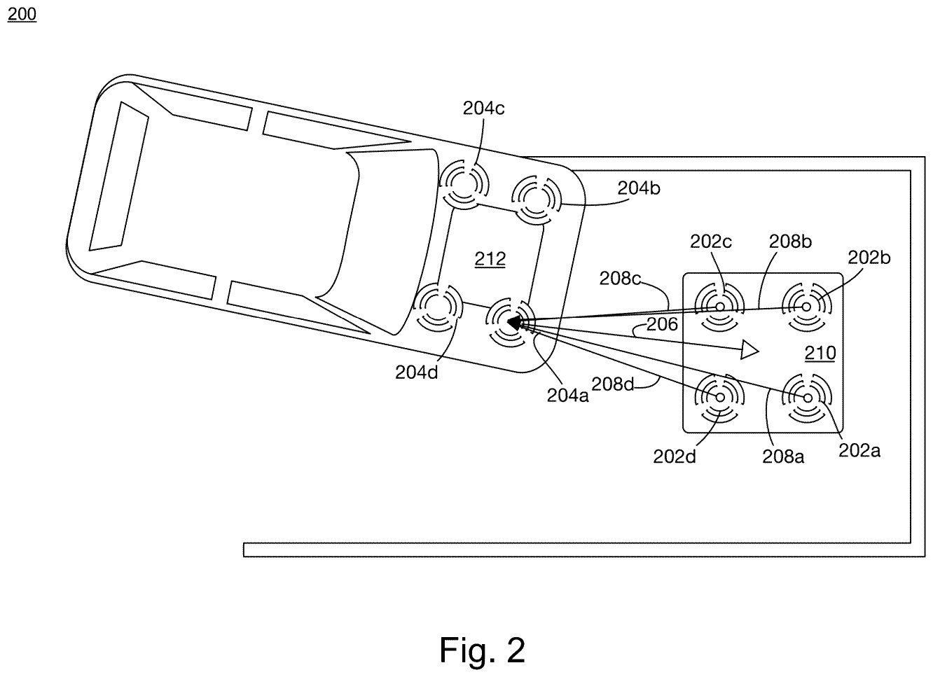

In some examples, the positioning system employs ultra-wideband (UWB) location technologies. UWB localizers may determine distance through measurement of a round-trip time of a pulse or other suitable wideband waveforms, similarly to secondary surveillance radar used in air traffic control or satellite ranging techniques. As shown in FIG. 2, in an exemplary embodiment 200, multiple UWB transceivers, which are referred to as UWB anchors 202a, 202b, 202c, 202d, associated with a GA pad 210 are suitably positioned within a parking lot area. These UWB anchors 202 are shown located inside the perimeter of the GA pad 210, but they could be located anywhere in the parking space. At least one UWB transceiver 204 is part of the VA, having an antenna suitably installed (e.g., within a VA pad 212). The example of FIG. 2 shows four UWB transceivers 204, which are referred to as UWB tags 204a, 204b, 204c, 204d. Each vehicle UWB tag 204a-d broadcasts a UWB ranging signal 206 (only shown for one tag 204a), which, when received by the UWB anchors 202a-d, triggers each of the anchors to transmit a UWB response signal 208a-d. These response signals 208 are preferably of the same waveform but delayed in time by a fixed and known amount or shifted in frequency or both, relative to the received ranging signal. Each vehicle UWB tag 204 measures the time of arrival of all response signals 208 that are responding to that tag's ranging signal and determines round-trip-time and related distance between itself and each of the anchors 202. By positioning multiple anchors 202 within the GA pad 210, the position of the GA pad 210 relative to the VA pad 212 may be determined through triangulation methods, as will be understood in the art.

Ultra-wideband location technologies may enable real-time, continuous position measurements with resolutions in the centimeter range. Moreover, code and time division channelization for a million localizers per km² may be achievable. By using multiple UWB tags in the vehicle and multiple UWB anchors in the parking space, not only range but relative angle may be determined, allowing the vehicle to be parked in precise alignment over the pad and properly within the parking space. Guidance and alignment may be provided visually or audibly to a human driver, or an autonomous driving system may directly park the vehicle based on the UWB-derived position data.

In yet another exemplary embodiment using UWB signals, one or more UWB transmitters are connected to the GA and multiple UWB receivers are connected to the VA. The vehicle-side PD system measures the relative time of arrival of the UWB signal in each of its receivers to determine a position or an angle of direction pointing to the GA pad. This technique may be referred to as differential time of arrival (DToA) and is generally known in the art. Also see U.S. Pat. Nos. 9,772,401 and 10,139,238, mentioned above, which are incorporated here by reference.

### UWB-Based Pairing

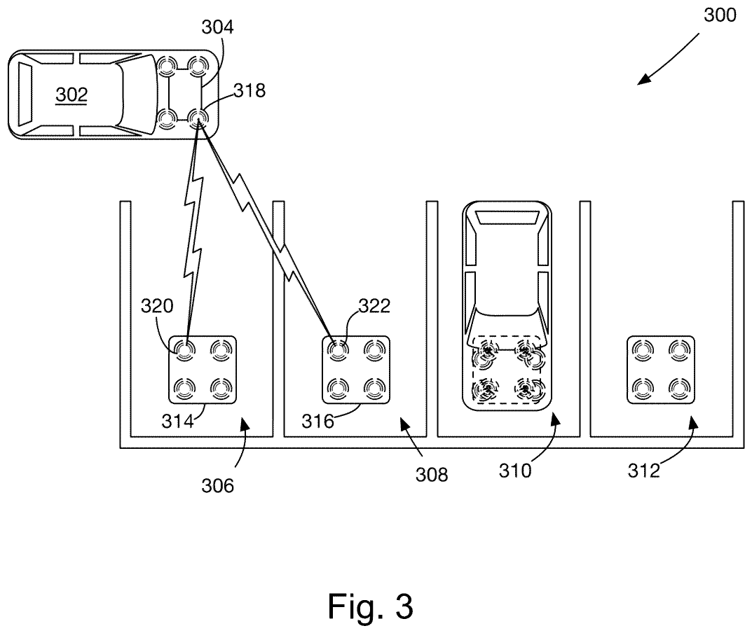

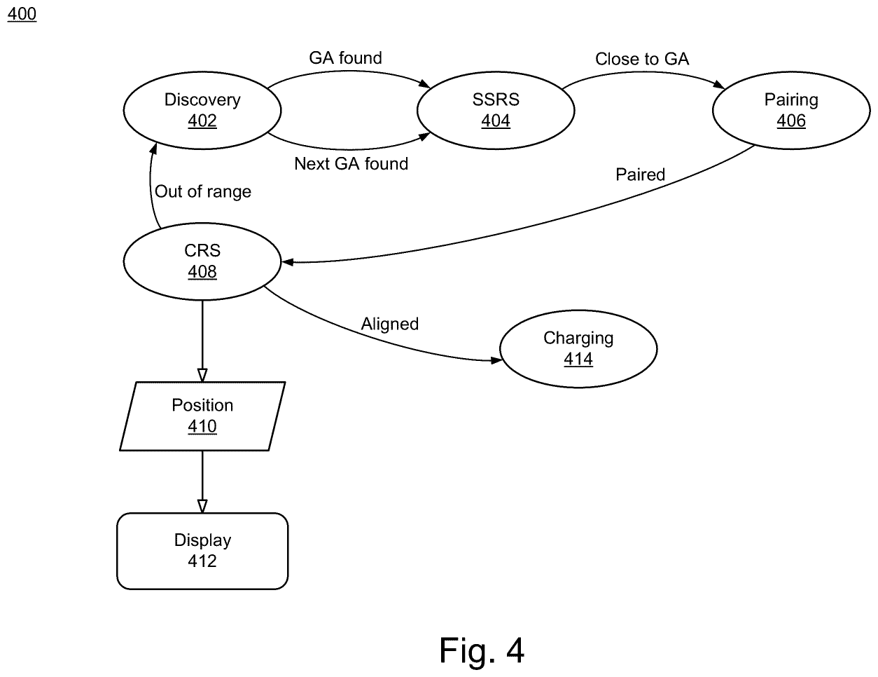

In addition to using position measurement to confirm that the vehicle is indeed properly parked over the GA pad it is to charge from, the UWB transceivers can also be used for digital communication, allowing the VA and GA to directly confirm each other's identity and provide the information necessary for establishing a Wi-Fi connection between them. FIG. 3 shows an example vehicle 302 with a VA pad 304 entering a parking area 300 and passing by parking spaces 306, 308, 310, 312. FIG. 4 shows a state diagram of a process 400 a VA and available GAs use cooperatively to select a parking space. Initially, the VA and GA are in a Discovery mode 402 (e.g., Discovery 402), during which the VA uses one of its UWB tags, designated a Master Tag 318, to broadcast a message asking any GAs that receive it to respond. In the example of FIG. 3, GAs 314, 316 in spaces 306, 308 receive the broadcast message and respond by using one of their UWB anchors, designated the Master Anchor 320, 322, for each GA. The GA in space 310 does not respond because it is already engaged with a car, and the GA in space 312 does not respond because it is too far away and does not receive the broadcast message. The VA and GAs 314 and 316 then enter into a single-shot ranging session (SSRS) mode 404 (e.g., SSRS 404), explained in more detail below. During the SSRS mode 404, the VA makes an initial determination of which GA is closest and enters a Pairing mode 406 (e.g., Pairing 406) with that GA. After the VA and GA are paired, they both enter into a continuous ranging session (CRS) mode 408 (e.g., CRS 408) to guide the vehicle into position for charging 414 or any other WPT operation as previously discussed. The VA provides position information 410 to a user interface 412 of the vehicle for display. In some examples of autonomous vehicles, the position information may be used internally and not displayed to passengers.

While in the CRS mode 408, the VA also continues to operate in the Discovery mode 402 and, if another GA is found, initiates another SSRS. If the vehicle drives past the closest parking space, as indicated either by another GA being found to be closer (or otherwise preferable) via the SSRS or by the vehicle moving out of an acceptable range during the CRS, the CRS is abandoned and the VA returns to the Discovery mode 402 or Pairing mode 406.

In order for the VA and GA to begin communicating with each other, they must share some common starting point to assure that messages sent from one are received and understood by the other. In addition, collisions and interference between transmissions from disparate devices should be avoided. In one example, for UWB communications, such settings as channel, sync-code, and encryption settings must be known by all systems that intend to communicate with each other. In some examples, a standard set of these parameters is defined, providing an open protocol for initiating the pairing and ranging process. To avoid collisions and interference, pre-defined frequency channels, sync-code, STS-Key-Encryption, and time-division-multiple access (TDMA) may be used. When using an open protocol, such that a VA from any manufacturer may connect to a GA from any other manufacturer, in addition to communication parameters, it is necessary for the VA and the GA to communicate information about their identity, their capabilities, and what accounts or networks the VA may use to pay for charging, if required. Once communication has been established, additional communications links may be established. Information about VA and GA compatibility may be exchanged as part of initial communications setup, or after communications have been established.

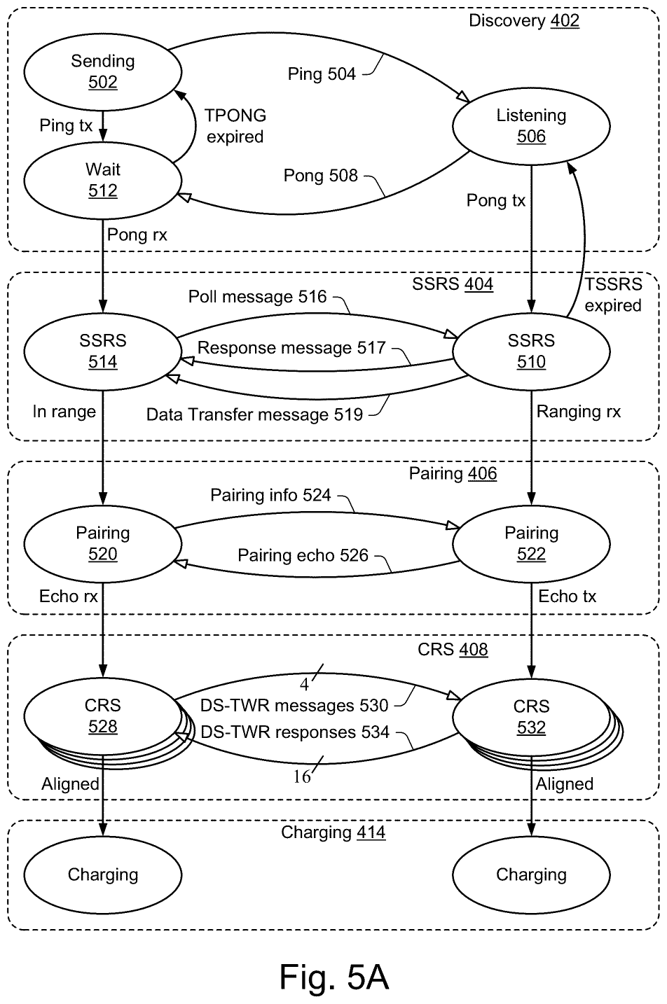

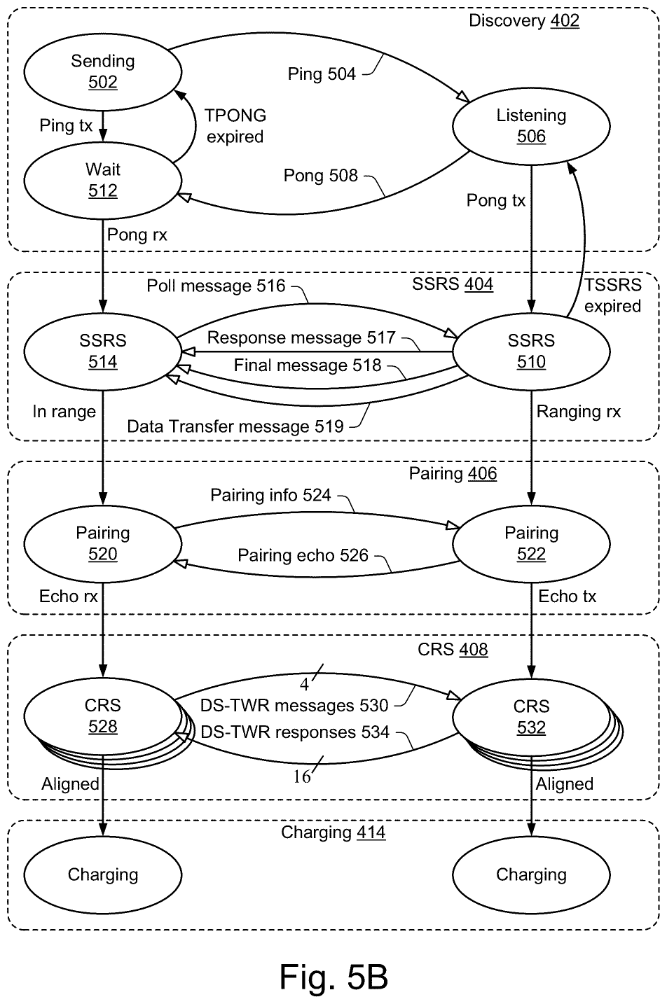

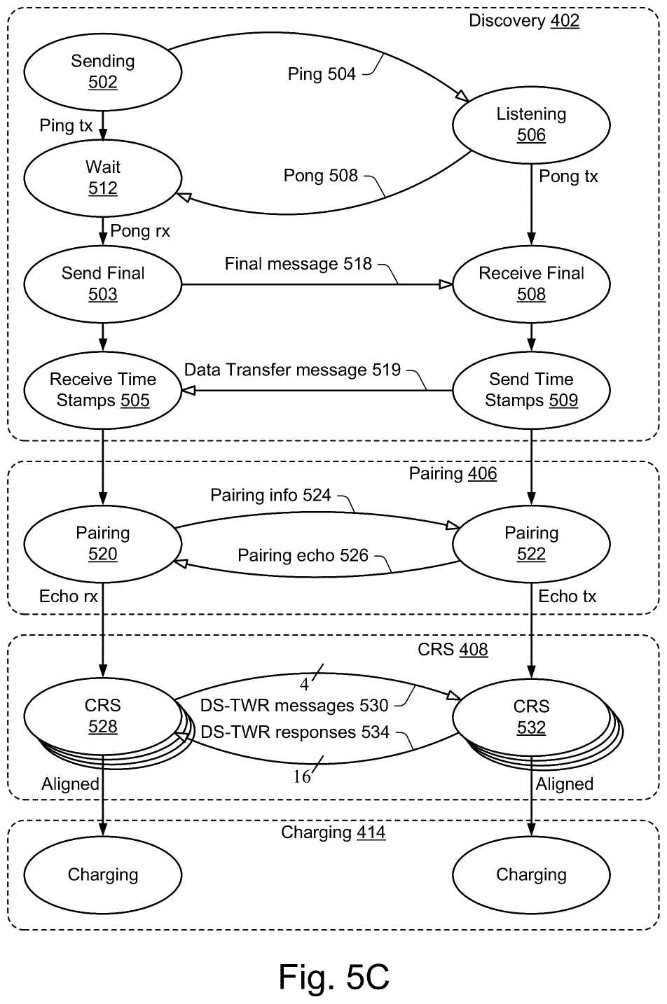

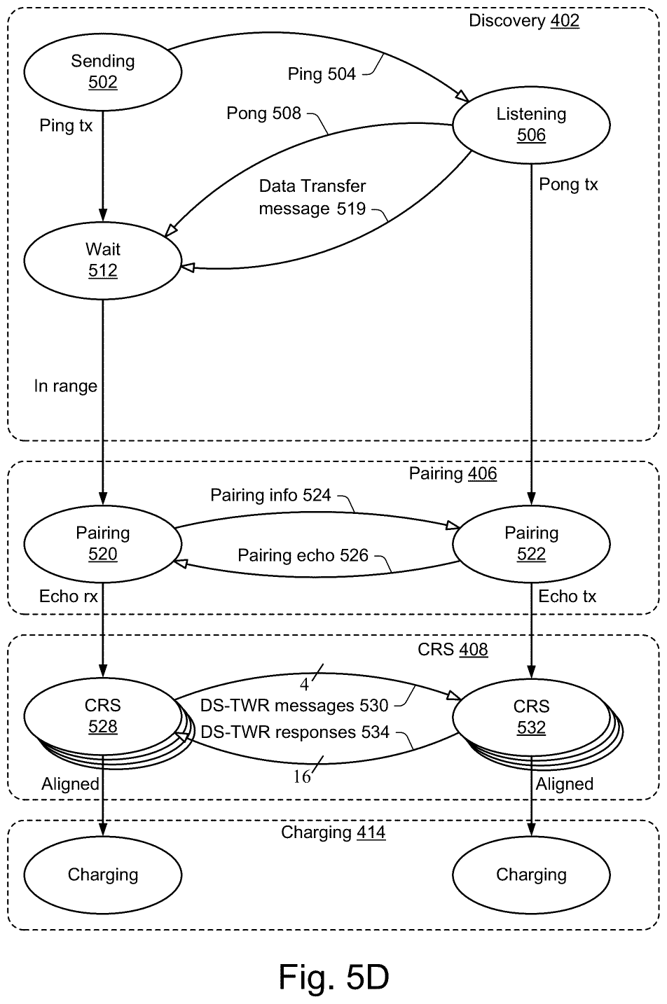

FIGS. 5A-5D show more detailed views of several options for implementing the discovery, ranging, and pairing states and messages from FIG. 4. The states of the VA are shown on the left, and the states of the GA are shown on the right. Messages exchanged between the tags in the VA pad and the anchors in the GA pad are shown in the middle. The dotted-line boxes correspond to states in FIG. 4 and are labeled accordingly. FIG. 5A shows an implementation using single-sided two-way ranging (SS-TWR) in the SSRS stage, while FIG. 5B shows a double-sided two-way ranging (DS-TWR). The initial steps, within the Discovery mode 402, are the same. Initially, the VA is in a Discovery Sending mode 502 (e.g., Sending 502), during which its Master Tag broadcasts a Ping message 504 (e.g., Ping 504, the UWB ranging signal 206). The Ping message 504 is transmitted repeatedly using an open protocol with standardized UWB settings. An example of standardized settings may be modulation type BPM-BPSK (burst position modulation-binary phase shift keying) using encoding scheme Conv_k3+RS_63_55, mean PRF (Pulse Repetition Rate) of 62.4 MHZ, data rate of 6.8 MHz, frequency channel CH9 with center frequency 7987.2 MHz and bandwidth of 499.2 MHZ, preamble-Sync-Code-9 (IEEE 802.15.4-2020 Table 15.7 code sequence 9 with 127 ternary symbols), preamble symbol repletion 64, Start-Frame-Delimiter-Pattern of type short as defined in (IEEE 802.15.4-2020 chapter 15.2.6.3), no encryption. Each of these parameters is given only as an example value.

The Ping message 504 includes a payload with a preamble-sync-code index randomly selected from the pool of CH9 permitted preamble-sync-codes defined in IEEE 802.15.4-2020 Table 15.7. The Ping message 504 may also, or alternatively, include an encryption key to ensure that the subsequent communication is unambiguously sent to the addressed participants to avoid cross-communication and misinterpretation of the messages. Additionally, the payload can include the VA-ID and VA-Type. The VA-Type data may include WPT-class, Z-class, and manufacturer. The GA begins in a Discovery Listening mode 506 (e.g., Listening 506), during which its Master Anchor is listening for Pings. The Master Anchor is tuned to the standardized settings so that it will receive a Ping from any VA operating according to the standard. Upon receipt of the Ping message 504, the Master Anchor reads the sync-code index and the VA identifiers. If the VA identifiers indicate that the VA is not compatible with the GA, the GA simply ignores the Ping and remains in the Discovery Listening mode 506. If the VA is compatible, then the Master Anchor transmits a response message, called a Pong message 508 (e.g., Pong 508, the UWB response signal 208). As the transmission of the UWB message can be considered as quasi-instantaneous, the sending time of the Ping message 504 can be used by the tag as a synchronization point and the reception time point can be used as a synchronization point for the anchors. As described above, the discovery communication can be parallelized with the CRS communication, which can fit into a defined positioning algorithm refresh rate time (e.g., 100 ms). The available time can be split into four time slots with the following time allocation: T_DISCOVERY=30% for the Discovery mode 402, T_SSRS=30% for the SSRS mode 404, T_PAIRING=10% for the Pairing mode 406 and T_CRS=30% to perform continuous ranging measurements in the CRS mode 408. The T_DISCOVERY and T_SSRS can be granulated down to 1 ms slots to implement the TDMA principle.

The Pong message 508 is transmitted using the preamble sync-code index from the Ping message 504. The payload of the Pong message 508 includes one or more randomly generated Session-Keys and Salted-Keys used to perform an encrypted SSRS communication, the GA-ID and GA-Type information, and information describing the geometrical arrangement of the anchors relative to the center point of the GA pad. If the Ping message 504 includes an encryption key, the Pong message 508 can be encrypted using that key, assuring that only the Master Tag that sent the Ping message 504 can interpret the response. In some implementations, the Master Anchor responds with the Pong message 508 within a specified time limit, called TPONG. The Master Anchor responds during a randomly selected time slot within TPONG to avoid collisions with other GAs that may be responding to the same Ping message. After the Master Anchor transmits the Pong message 508, the GA moves on to the SSRS mode 510 (e.g., SSRS 510). The VA waits 512 for the Pong message 508. If the VA receives the Pong message 508 within time TPONG, it also moves on to the SSRS mode 514 (e.g., SSRS 514); otherwise, it returns to the Discovery Sending mode 502 and broadcasts the next Ping message. In some examples, as mentioned above, the VA continues to operate in the Discovery mode 402 and broadcast Pings in parallel to conducting SSRS, Pairing, and CRS with responding GAs.

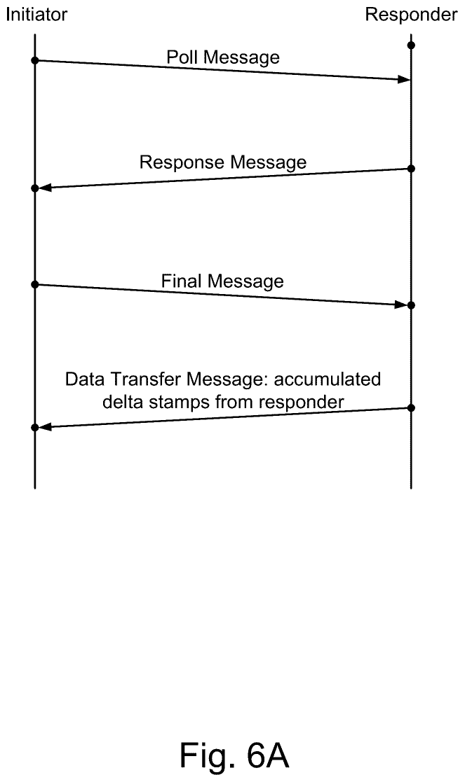

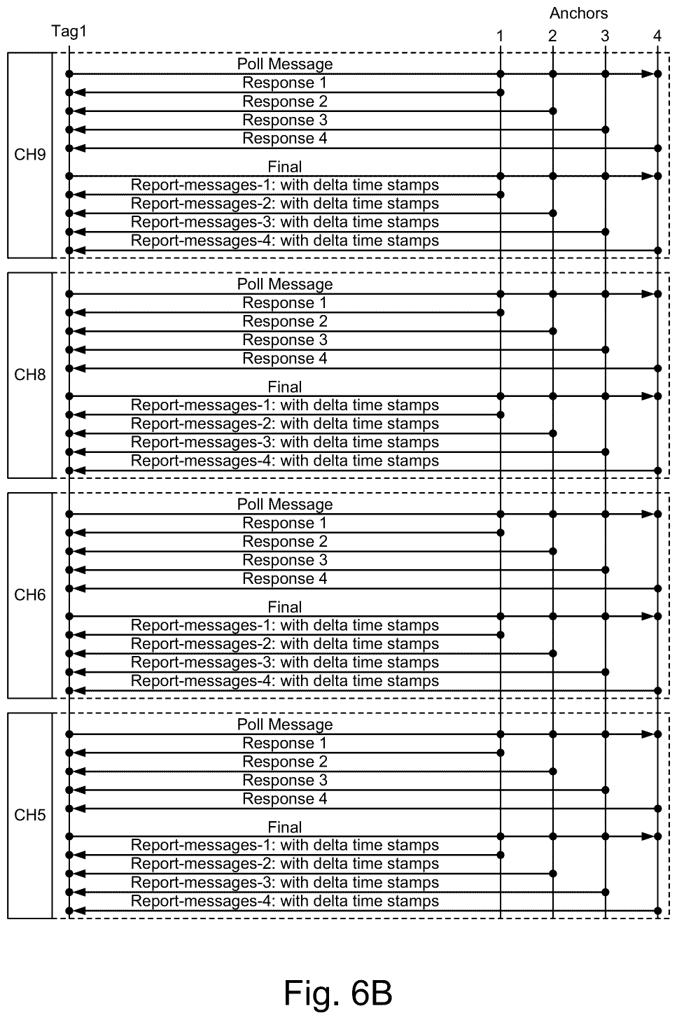

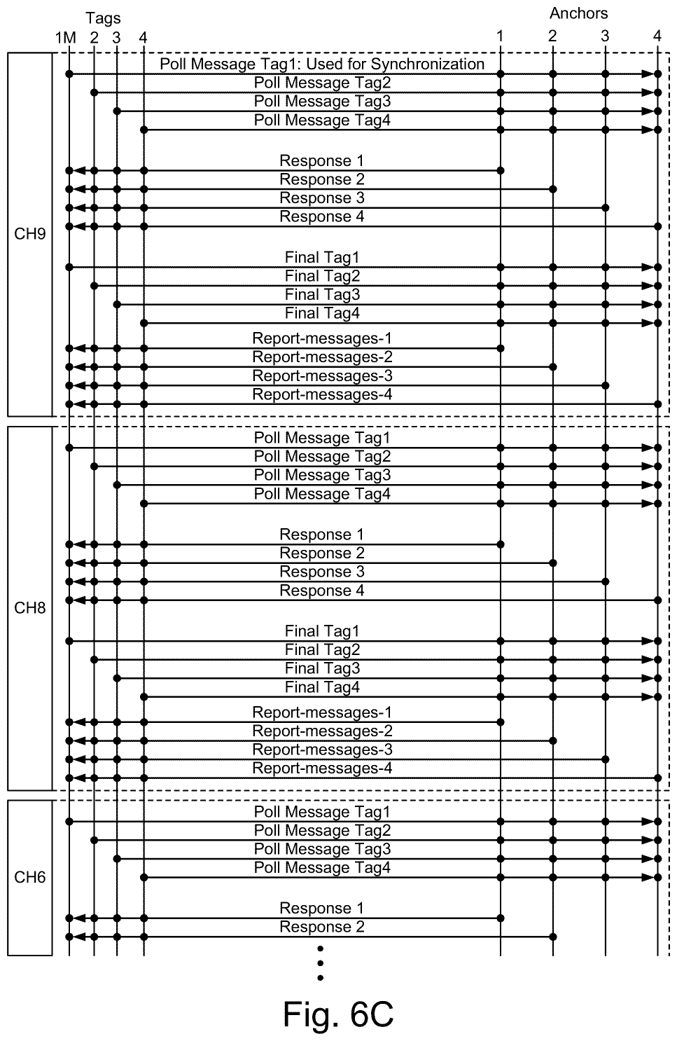

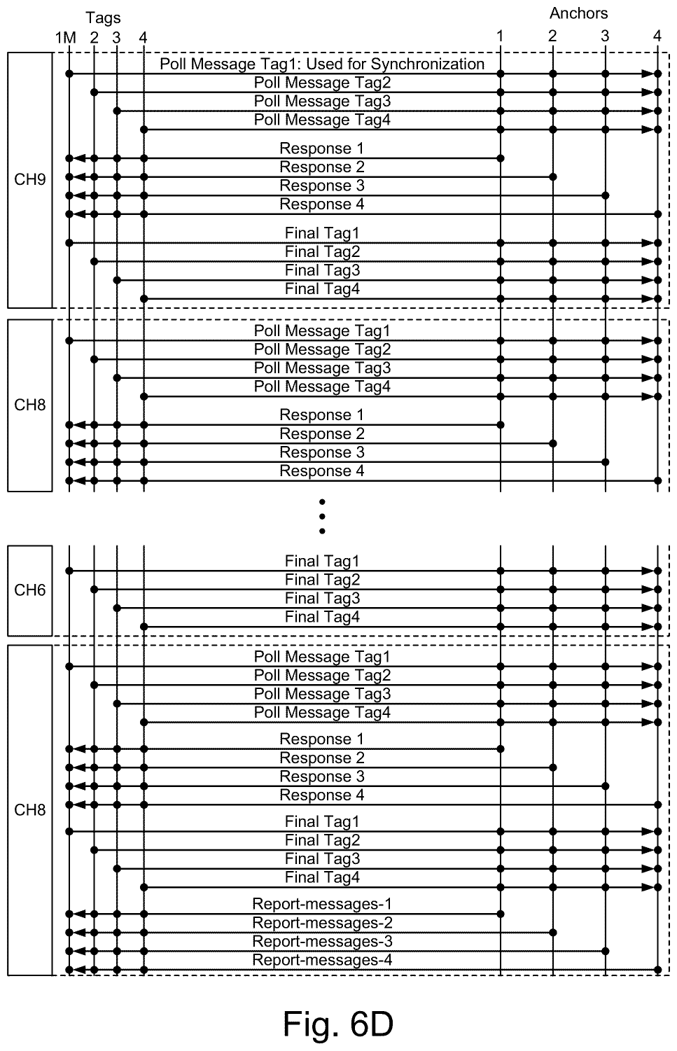

In the SSRS mode 404, a SS-TWR method, as in FIG. 5A, or DS-TWR method, as in FIG. 5B, can be used to determine the distance between the Master Tag and Master Anchor. The Master Tag uses the Session-Key and Salted-Key received in the Pong message 508 as well as previously defined preamble sync-codes to establish a unique Poll message 516 to the Master Anchor. The Master Anchor responds with a Response message 517. In the DS-TWR implementation, the Master Tag then sends a Final message 518. In both SS-TWR and DS-TWR, the Master Anchor sends time stamps to the Master Tag in a Data Transfer message 519. The sequence of messages in DS-TWR is also shown in FIG. 6A. The Response message 517 and the time stamps in the Data Transfer message allow the Master Tag to determine the rough distance to the Master Anchor. If the rough distance is within a threshold distance for reliable distance measurements, the VA moves on to the Pairing mode 520 (e.g., Pairing 520). If the Master Anchor didn't receive the Response message 517 within a time period TSSRS after sending the Pong message 508, the GA returns to the Discovery Listening mode 506. Otherwise, the GA moves on to the Pairing mode 522 (e.g., Pairing 522) automatically after the Master Anchor transmits the Data Transfer message 519 to transfer the time stamps.

In another example, as shown in FIGS. 5C, and 5D, the Discovery mode 402 and the SSRS mode 404 can be combined into one combined discovery mode, where the Ping and Pong messages are used at the same time to determine the time stamps and transfer the data. The main differences between this method and the examples in FIGS. 5A and 5B are the number of messages required to finish the discovery stage and the fact that the sync code and STS-Key are defined only one time by the Master Tag. The Ping message 504 is sent on an open protocol, but the following Pong message 508, the Final message 518, and the Data Transfer message 519 are all sent using the same preamble sync code and new STS-Key sent in the Ping message 504 by the Master Tag. The Master Tag remains in a reception mode for a predefined time (e.g., T-Poll=30 ms). After each reception of a Pong message, the Master Tag records the time stamps and data from the payload and returns to the reception mode. The Master Anchor sends the Pong messages within the predefined period T-Poll in a predefined raster (e.g., 1 ms), using the TDMA operating principle. Additionally, an increase of the STS Key-Index can be implemented for each raster step to add more security in the ranging operation. After expiration of T-Poll, the Master Tag enters a Send Final state 503 and the Master Anchor enters a Receive Final state 507, where the Tx and Rx time stamps are recorded on the tag and anchor side respectively and the Master Tag sends the Final message 518. In a final discovery step of the Master Anchor (e.g., Send Time Stamps 509), the Master Anchor sends the Data Transfer message 519 during time T-Data-Transfer using the same raster division and TDMA principle. In the Data Transfer message 519, the time stamps are transferred in the payload as well as new encryption settings for the following pairing session, as the pairing request shall be addressed individually to only one anchor located in the tolerance range. In a final discovery step of the Master Tag (e.g., Receive Time Stamps 505), the Master Tag receives the Data Transfer message 519 including the time stamps and the new encryption settings.

If the precision of the SS-TWR is sufficient, the discovery method can be shortened further by skipping the Final message 518 and allocating the Pong message 508 and Data Transfer message 519 in the same time raster as shown in FIG. 5D. Although the ranging algorithm can be combined with data transfer, the Data Transfer message 519 cannot be skipped as it is used to transfer the last Tx Time-Stamp of the Pong message 508, which can be determined only after the Pong message 508 has been transferred.

In each of the examples of FIGS. 5A-5D, upon entering the Pairing mode 520, the Master Tag sends Pairing information 524 to establish the CRS, including radio settings, channel hopping settings, sync-code, and encryption keys. The Master Tag then listens for a Pairing Echo 526 from the Master Anchor. The Pairing Echo 526 confirms successful reception of the pairing request and can include additional data from the GA as calibration parameters. Once the Pairing Echo 526 is received, the VA enters the CRS mode 528 (e.g., CRS 528), in which all four tags execute DS-TWR sessions with all four anchors, sending the Poll and Final messages (e.g., DS-TWR messages 530). Likewise, after sending the Pairing Echo 526, the GA enters the CRS mode 532 (e.g., CRS 532), in which all four anchors receive the four transmitted messages (e.g., DS-TWR messages 530) and respond to each with responses (e.g., DS-TWR responses 534). In total, then, 16 communication links are established among the tags and anchors, allowing precise location, including rotation and vertical offset, to be determined. FIG. 6B shows the interleaving of the messages involved.

FIG. 6B shows an example message flow for interleaved DS-TWR. The DS-TWR method in general is a well-known state-of-the-art method used in UWB ranging applications. The advantage of a DS-TWR method compared to an SS-TWR method is the higher precision provided by the additional “Final Message,” which allows compensation of the relative clock drift. The two-way ranging method consists of three ranging messages often called in literature the Poll-Message, Response-Message, and Final-Message. An additional message called the Report-Message is optional but is used in the present vehicle ranging application as the vehicle acts as an initiator for the discovery and pairing sessions as well as the CRS with all 16 links to determine its position relative to the GA pads during the parking maneuver. Thus, the Report-Message is used to transfer the collected time stamps from anchor to initiator (e.g., the tag sending the Poll message). So in this example, in total, four UWB messages are required to accomplish one distance measurement for one link, one tag to one anchor. As there are four tags and four anchors involved, the number of required UWB messages increases to 64 if executed sequentially.

The example FIG. 6B makes use of frequency channel diversity to improve the precision in a multipath environment. As the antennas of the tags and anchors are embedded in the VA pad and GA pad and surrounded with materials of different properties, there may never be a direct line of sight between any of the tags and any of the anchors, and there will always be reflections of signals present, which might overlap and, depending on the phase, will result in constructive or destructive interference, leading to falsification of the signal and introducing multipath errors. There are several ways to improve precision of the measurement in a multipath environment. One way is to increase the bandwidth of the UWB signal. A second way is using antenna diversity where two antennas are located at least one-half wavelength of the carrier frequency apart from each other and the signals are received by two synchronized receiver modules. The second way is repeating the measurement using frequency diversity, where the same measurement is repeated with different carrier frequencies of the UWB signal. In FIG. 6B, there are four channels used, each repeating the same measurement. Thus the number of required UWB messages increases to 256 UWB messages if all ranging sessions are executed sequentially. Considering a time raster of, for example, 500 us for UWB messages, the total time increases to 128 ms, which exceeds the desired position refresh rate of 100 ms. In addition, the air utilization time where the UWB messages are occupying the channels is high.

To decrease the number of the UWB messages required to cover all 16 tag-anchor link combinations and four frequency channels, an interleaved DS-TWR method can be used. The example of FIG. 6B shows the complete ranging of one tag to four anchors. The main difference from the sequential execution of the DS-TWR sessions is the fact that the Poll message and Final message are sent only one time by the tag. The response messages are sent from anchors in a time raster dependent on their ID. This method allows reduction of the number of UWB messages to 10 for one tag to all four anchors, repeated for each channel. The total number of UWB messages for 16 links and four frequency channels is reduced to 160 UWB messages.

The example of FIG. 6C shows another progression of the interleaved DS-TWR method, which can be called a Multi-Tag to Multi-Anchor interleaved DS-TWR method with frequency diversity. The idea of this method is to synchronize all tags of the VA and all anchors of the GA to the first poll message sent by a Master Tag 1M, which is considered the synchronization master. After the power-up and after the finish of every ranging session, the tags and anchors wait in the reception mode for the Poll message from Tag 1M. After the Poll message from Tag 1M is received, tags 2 to 4 send their Poll messages in a pre-defined time raster in time slots dependent on their IDs. The anchors send the Response messages in the same time raster in specified time slots depending on their IDs. By applying this method, the number of UWB messages can be reduced even further to 16 messages per channel to cover all 16 tag-anchor link combinations. In this example, a total of 64 UWB messages are required to cover all tag-anchor links and all frequency channels. Note that FIG. 6C only shows two first sets of messages in their entirety; the third channel is cut off and the fourth channel is not shown for simplicity of the illustration.

As shown in FIG. 6D, the Report-Messages may be sent only one time, after finishing all ranging sessions in all frequency channels, which allows further reduction of the number of UWB messages to 52 total. For simplicity, the end of the second channel block of messages and the beginning of the third are omitted.

Applying the interleaved DS-TWR method with multi-tag-anchor links has a potential to reduce the total number of UWB messages from 256 using sequential execution down to 52 UWB messages, resulting in faster execution times, lower energy consumption, and lower frequency channel utilization time.

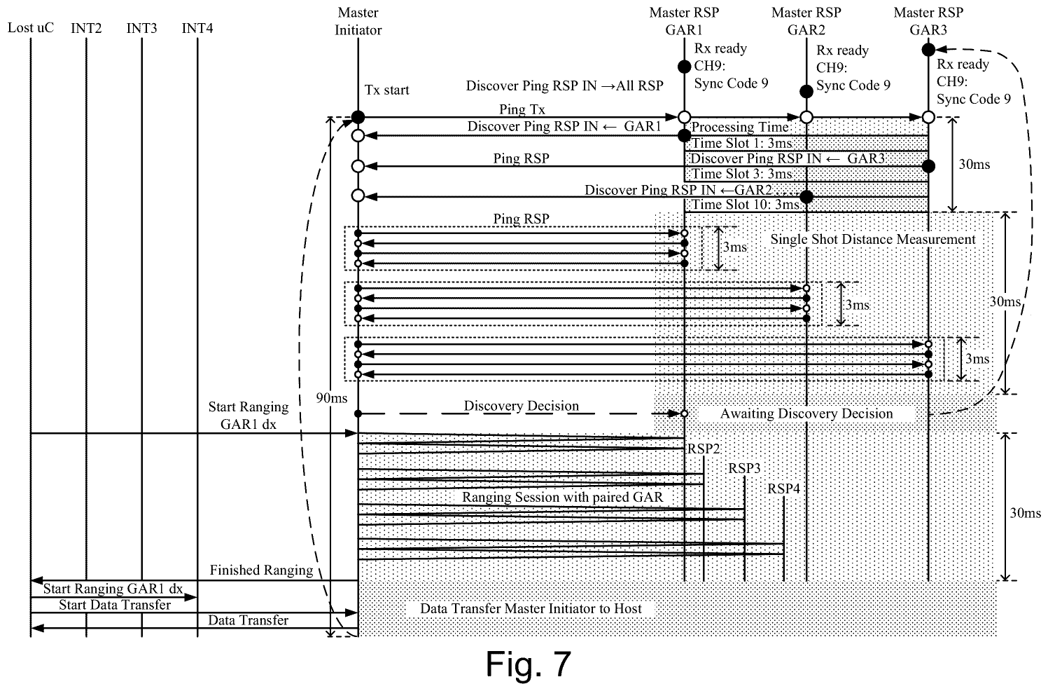

As mentioned above, the VA may perform Discovery and SSRS with more than one GA at a time. A more detailed example of the message flow for this is shown in FIG. 7. To establish confirmed one-to-one communication between the VA and GA, the initial Ping message from the Master Tag includes a random preamble sync-code from the pool of permitted sync codes and is sent on a standard-determined channel (e.g., CH9). Each responding Master Anchor selects a random time slot for its Pong reply, and the Pong Message is sent using the preamble-sync-code from the Ping. As shown in FIG. 7, three responding GAs send their responses in time slots 1, 3, and 10. The VA then performs SSRS with each of the GAs to discover which is closest. As an additional measure to avoid collisions during the SSRS, the Master Anchor of each GA provides a randomly generated 16-byte STS-Key. When the Master Anchor of one GA intercepts the SSRS messages meant for another, the STS-Key will not match and that Master Anchor can simply re-initiate its SSRS session. The VA chooses GA1 and moves on to pairing and the CRS with that GA. Finally, once the vehicle is aligned, the VA and GA1 engage in the additional data transfer needed to initiate and maintain a charging session.

Returning to FIGS. 4 and 5, once the vehicle has come into alignment over the GA pad, the UWB communication link may continue to be used for communications related to initiating the charging 414. In other examples, Wi-Fi is used for charging session-related communications. As mentioned above, the UWB link established for parking spot selection and alignment can also be used to exchange Wi-Fi connection information to allow the vehicle to join the correct Wi-Fi network for communicating with the GA. At minimum, the SSID and passwords, keys, or other credentials needed for connecting to it are provided from the GA to the VA via the UWB link between the Master Anchor and Master Tag. Once the VA and GA are connected through Wi-Fi, any additional communications needed, such as those called for by standards like SAE J2954 or ISO 15118, can be carried out over Wi-Fi.

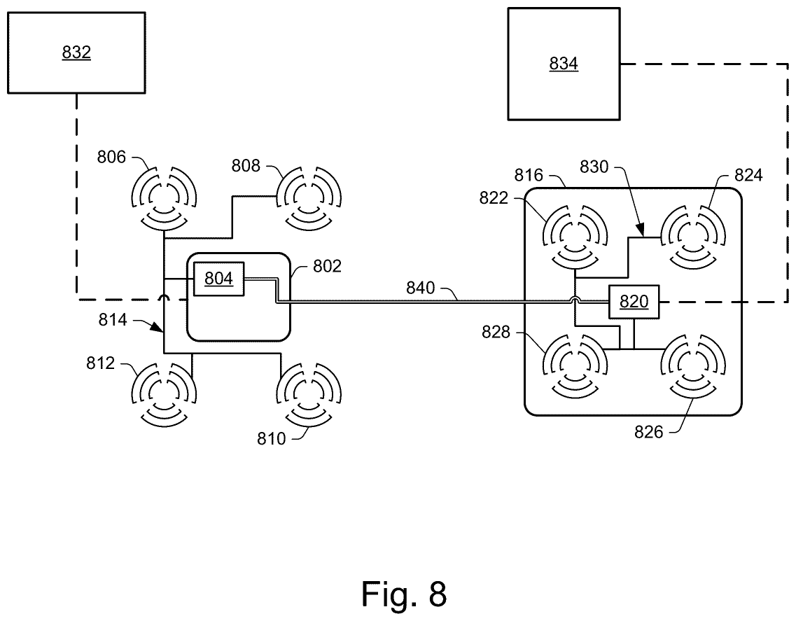

FIG. 8 shows an example architecture of the system. In a VA pad 802, a microprocessor 804 is in communication with four UWB Tags 806, 808, 810, 812 over a serial peripheral interface (SPI) bus 814. In a GA pad 816, another microprocessor 820 is in communication with four UWB anchors 822, 824, 826, 828 over another SPI bus 830. While the microprocessors 804, 820 are shown located in the VA pad 802 and GA pad 816, they could also be located in separate electronics enclosures of a VA 832 and GA 834. The SPI buses 814, 830 may each extend between the corresponding resonator enclosures and electronics enclosures, or the communications may be relayed over another communication layer, such as ethernet, universal asynchronous receiver-transmitter (UART), or a controller area network (CAN) bus. A communication link 840 is shown between the VA microprocessor 804 and the GA microprocessor 820. This communication link 840 represents the communications between the VA and GA that are enabled by the UWB system. As mentioned above, the communication link 840 can use the UWB system directly, or it can be Wi-Fi or some other form of wireless communication. While shown as directly connecting the microprocessors, there may be additional components involved; for example, the microprocessors 804 and 820 may be used only for controlling the UWB system, while another application processor (not shown) manages the communications between the VA and GA.

### Lifetime Limitation of UWB Transceiver Devices

In certain implementations, a Mean Time Between Failures (MTBF) of a UWB transceiver device may be limited depending on the operating duty cycle and device temperature. If continuously operated in a receive mode, the lifetime of some commercially available UWB transceiver devices may be limited to the order of 5000 hours (200 days). In a transmit mode, the MTBF of these UWB devices may be even shorter. Such lifetime limitation may result from a gradual performance degradation of a semiconductor device (ageing) and is becoming more prominent with increasing integration density (e.g., in nano-scale integrated circuits (ICs)). This degradation can be explained by a steadily growing damage in the silicon crystal lattice structure due to electron collision impacts whose probability exponentially increases with temperature. The use of nano-scale UWB transceiver ICs in wireless charging infrastructure may require implementation of special measures to increase the MTBF to an acceptable level. Examples of such measures are described and discussed below.

### Increasing the MTBF of Ground-Based UWB Transceivers

With reference to FIGS. 3, 4, and 5A to 5D, the Master Anchors 320, 322 must be Listening 506 for the Ping 504 when in Discovery 402. In some implementations, the Master Anchors 320, 322 are in Discovery 402 if not in another state such as SSRS 404, Pairing 406, CRS 408, and Charging 414. In typical use cases, Listening 506 may constitute a large percentage of the operating time of a Master Anchor. In Listening 506, the Master Anchor is in the receive mode most of the time.

In one implementation, the MTBF of a ground-based UWB transceiver is increased by passive or active cooling (e.g., using a Peltier element or liquid cooling of the UWB transceiver device (not shown)).

In another implementation, the MTBF of a ground-based UWB transceiver is increased by sharing the role of the Master Anchor (e.g., Master Anchor 320) among the Anchors 202a to 202d of the GA pad 210 with reference to FIG. 2. Propagation of a UWB signal over several meters from the vehicle-based Master Tag 318 may generally be less favorable to the Anchors 202a, 202b at the rear side of the GA pad 210 than to the Anchors 202c, 202d facing the Master Tag 318. Therefore, in some examples, only the front Anchors 202c and 202d may assume the role of the Master Anchor 320, resulting in an increase of MTBF by a factor of 2.

In a further implementation, the MTBF of a ground-based UWB transceiver is increased by activating the Master Anchor for Listening 506 only after a vehicle has joined the Wi-Fi network of a wireless charging station or infrastructure. In some implementations, a wireless charging-related Wi-Fi network is identified and distinguished from other Wi-Fi networks by a specific range of SSID. In some implementations, the Master Anchor remains active as long as UWB position detection (PD) is used. When a UWB PD session has terminated, the Master Anchor returns to a hibernating mode.

In a wireless charging infrastructure where multiple GAs share a common Wi-Fi access point (WAP), the Master Anchor of all GAs will be activated, resulting in undesired and unnecessary activity in many ground-based UWB transceivers. If the number of GAs sharing the same WAP is small, Wi-Fi-based activity control may still be beneficial.

In a wireless charging infrastructure where each GA provides its own WAP and where WAPs are operating independently without information exchange (e.g., in absence of a central network management system), Wi-Fi-based activity control of the Master Anchor may not be effective unless the vehicle knows the individual SSID of the WAP associated with the desired parking space. In a system where a driver or an Autonomous Driving System (ADS) is free to select any available parking space equipped with wireless charging, the vehicle may not know the individual SSID in advance. In this case, an approaching vehicle can potentially connect to any of the WAPs, resulting in a failed activation of the desired Master Anchor. Identifying and selecting the right WAP without knowing its SSID in advance requires an adequate ranging or localization capability, which may not be supported by conventional Wi-Fi technology operating in the 2.4 GHz and 5 GHz bands.

In certain use cases such as home garage and business parking, the SSID may be a priori known to the vehicle. The SSID may also be known in parking facilities managed by a central parking space assignment system, where vehicles are assigned a parking space upon registering to the Wi-Fi network. For these use cases, Wi-Fi-based activity control of the Master Anchor in a multiple parking space scenario may be effective and may result in reduced operating time of ground-based UWB transceivers.

The above conclusions may also apply to large parking lots covered by multiple WAPs each shared by a group of GAs and where WAPs are operating independently without information exchange (e.g., in absence of a central network management system). In the case of a centrally managed Wi-Fi network, Wi-Fi-based activity control of the Master Anchor may be effective but may result in high activity of ground-based UWB transceivers, and thus little gain in MTBF may be expected.

Further, joining an unknown Wi-Fi network may take more than 10 s if the vehicle-onboard Wi-Fi receiver needs to scan through multiple Wi-Fi channels in the various frequency bands (e.g., 2.4, 5, and 6 GHZ) searching for a wireless charging Wi-Fi network. In certain scenarios, acquiring a new Wi-Fi network may last longer than the time needed for the vehicle to reach the parking space where it needs guidance from the UWB PD system. Such delayed activation of the Master Anchor may negatively impact a user experience for parking to charge.

In another implementation, the MTBF of ground-based UWB transceivers is increased by operating the Master Anchor in Listening 506 in a low duty cycle receive mode. To maintain a specified Master Anchor discovery time, the duty cycle for Sending 502 of the Ping 504 may be increased instead. Increasing the duty cycle for Sending 502 may however reduce the MTBF of VA-based UWB Tags and may also conflict with some regulatory constraints requiring the average transmit power to be below certain limits. If the Master Tag is located several meters from the Master Anchor, full transmit power may be required and the regulatory limit may be exceeded.

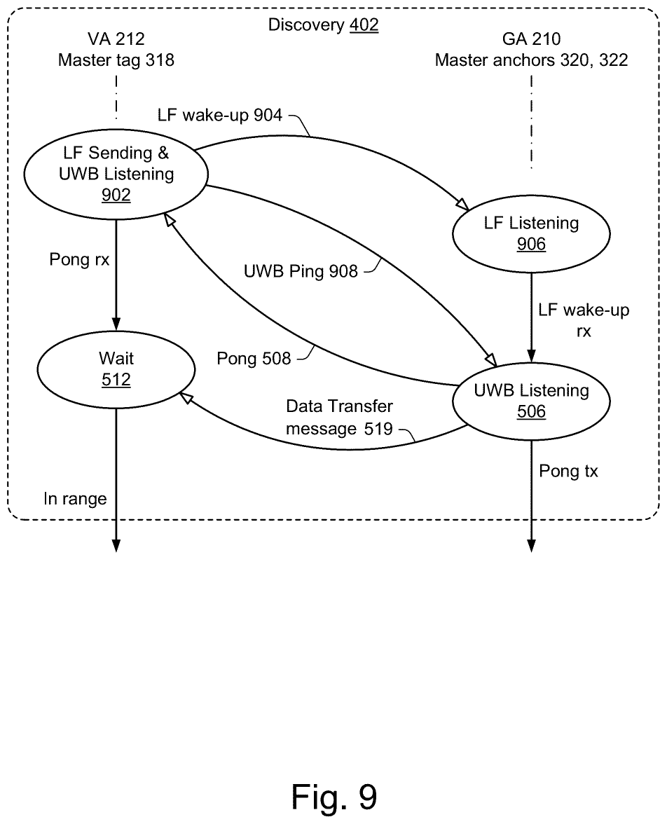

Using an alternative signaling technology to wake up the Master Anchor 320 may substantially increase the MTBF of ground-based UWB transceivers. In some implementations, Discovery 402 as illustrated in FIGS. 5A to 5D is extended by initially sending a low-frequency magnetic near field (LF) signal from an LF transmitter in the VA pad 212 to an LF receiver in the GA pad 210. This LF signal may be used to wake up the Master Anchor (e.g., Master Anchor 320). The extended Discovery 402 is illustrated by the process diagram of FIG. 9 showing states, state transitions, and signaling between the Master Tag 318 and Master Anchor 320. Discovery 402 as illustrated in FIG. 9 includes sending, in an LF Sending & UWB Listening state 902 (e.g., LF Sending & UWB Listening 902), an LF Wake-up signal 904 from the VA pad 212 to the GA pad 210, which is in an LF Listening state 906. Upon reception of the LF Wake-up signal 904, the GA pad 210 may activate the Master Anchor 320 for UWB Listening 906 as illustrated in FIG. 9. The remaining steps of the process remain as in the earlier examples and are not shown.

In some implementations, the LF wake-up signal 904 is transmitted at a frequency in a range from 100 to 145 kHz and at a common frequency shared by all vehicles. As opposed to electromagnetic far fields such as used by UWB, Wi-Fi, or Bluetooth decaying linearly with distance, magnetic near fields follow a third-order power law. Therefore, they can provide a well-defined reach (e.g., 5 m from a VA pad) and thus a more restricted activation of the Master Anchors 320, 322 for Listening 906. Using an LF wake-up signal 904, only Master Anchors in the reach of the LF wake-up signal 904 will be activated, which may result in substantial savings in operating time of the ground-based UWB transceivers in the various scenarios as discussed above. In some implementations, the VA transmits the LF wake-up signal 904 concurrently with the UWB Ping 908 (e.g., Ping 504). It may also be appreciated that the MTBF of the low-complexity LF transmitter and the LF receiver as used aboard the vehicle and in the GA, respectively, may be orders of magnitude larger than that of a UWB transceiver, thus not requiring a tight activity control.

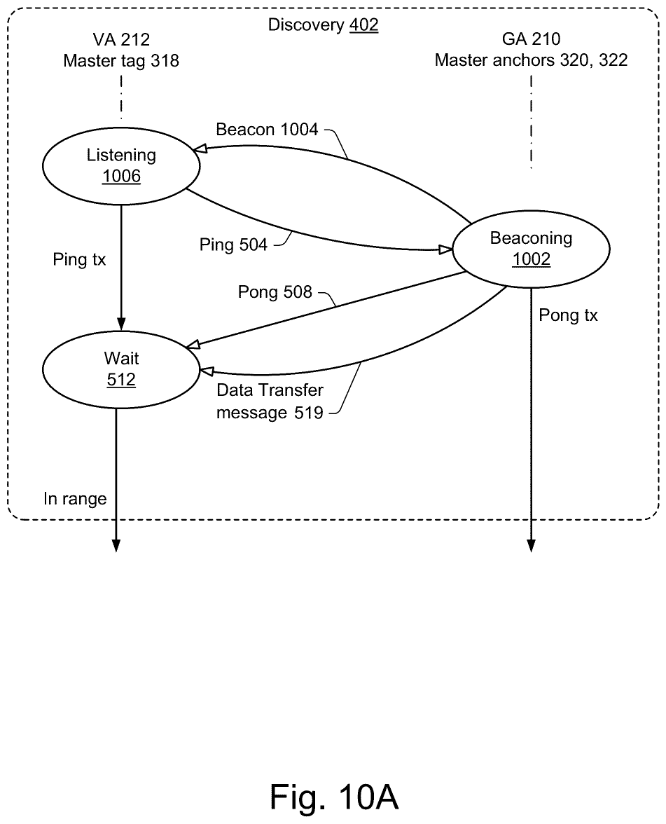

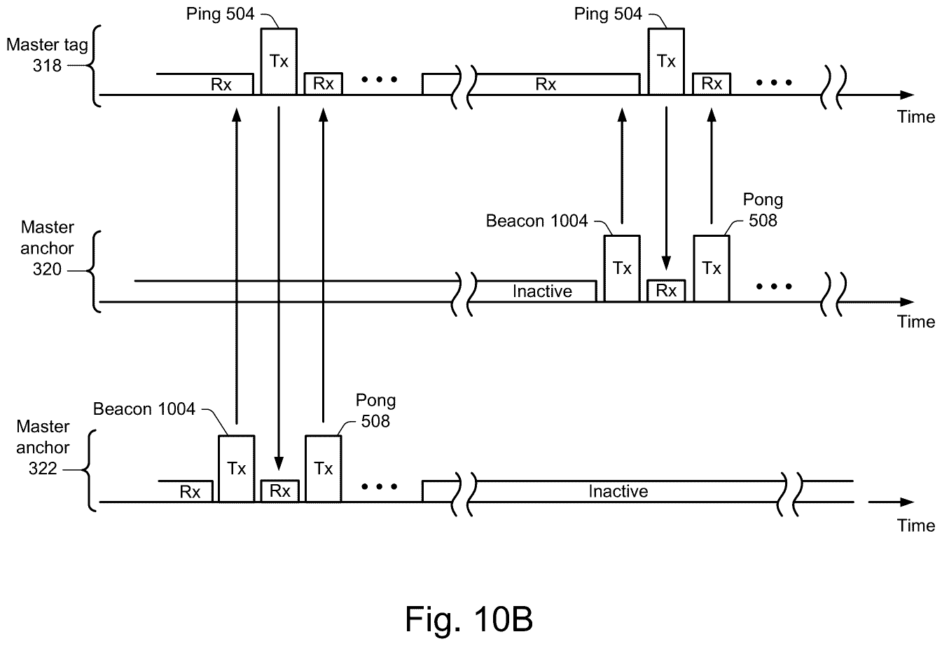

In a further implementation, the MTBF of ground-based UWB transceivers is increased by configuring the Master Anchors 320, 322 to transmit a UWB beacon signal in Discovery 402 in a low duty cycle transmit mode, to listen for a potential response from the Master Tag 318 in a low duty cycle receive mode, and to stay inactive (hibernating) for the rest of the time. This is illustrated by the progress diagram of FIG. 10A showing states, state transitions, and signaling between the Master Tag 318 and Master Anchors 320, 322. In a Beaconing state 1002, the Master Anchors 320, 322 periodically transmit a Beacon 1004 (e.g., Poll message) in a short time interval and listen for a potential Ping 504 from the Master Tag 318 in a short interval following the Beacon 1004 interval. The Master Tag 318 exits a Listening state 1006 after sending the Ping 504. Upon reception of the Ping 504, the Master Anchors 320, 322 respond with a Pong 508 or Data Transfer message 519.

An example low duty cycle Beaconing state 1002 is also illustrated by a time diagram of FIG. 10B displaying the activity of the Master Tag 318 and Master Anchors 320, 322. The diagram indicates various time intervals for transmitting (TX) and receiving (RX) of the Beacon 1004, Ping 504, and Pong 508 and for resting inactive (hibernating). To avoid collisions in a multiple parking space scenario where the Beacon 1004 is transmitted by each Master Anchor, a TX interval may be short relative to a Beacon 1004 repetition period. As illustrated in FIG. 10B, a Beacon 1004 may be transmitted by each Master Anchor with a random time offset such as that resulting in a system using unsynchronized Master Anchors. If the Master Tag 318 receives Beacons from several Master Anchors, the Master Tag 318 may respond with a Ping 504 to each of the Master Anchors in corresponding time intervals. In some implementations, the Master Anchors respond with the Pong 508 and subsequent communications between the VA and the GA (including pairing) follow one of the processes illustrated in FIGS. 5A to 5D.

In some examples, the Beacon 1004 is sent every 1 s during a slow interval, which is sustained as long as no vehicle has been detected within an activation zone, such as a radius of 10 m around the GA. When such a vehicle is detected, the GA changes to a fast interval of, for example, 100 ms. To avoid collisions, each GA randomly selects a time slot and periodically scans for beacons from other GAs to determine an available time slot and avoid collisions. The scan is conducted for the full length of the slow interval, to detect any other GAs that are themselves transmitting on the slow interval. During this scanning, the GA also determines the signal strength of each detected beacon signal. If the facility is so crowded with GAs that no time slot is available, the GA will choose a time slot with the lowest-power competing GA, as that GA is likely to be the farthest away, and thus the two GAs are unlikely to be activated by the same vehicle. On the rare occasion that two GAs that chose the same time slot are concurrently in the fast interval mode, collisions still remain unlikely, as the UWB messages in question require airtimes much shorter than 1 ms.

In some examples, the pairing process proceeds as follows. After reception of the response message, the GA calculates the SS-TWR distance and angle of arrival. The values are written into the response list with corresponding data received from the payload. The main reason to maintain the list is to record the history to check plausibility and consistency of the data, instead of relying on one snapshot. If the GA detects that the VA entered a fast-sampling zone (e.g., calculated SS-TWR distance is below 10 m and angle of arrival is below) 15°, it will change to a fast sampling mode and send the poll messages in 100 ms intervals. If the GA detects that the distance is below a pairing threshold (e.g., <5 m) and the data is consistent, the angle of arrival is below an angle threshold and the data is consistent, and the GA-VA compatibility is given, then the GA responds with a Final message containing information such as a Wi-Fi SSID, a Wi-Fi Password, Wi-Fi Access Point settings, and supported DS-TWR sequence schemes including time scheduling. This message can also be understood as a proposal of the GA to change to continuous ranging, as all the parameters from the GA point of view are fulfilled.

The Final message is scheduled and is sent exactly 1 ms after sending the Beacon 1004. The Final message is coded with an STS-Key, which was defined by the VA and transmitted to the GA in the payload of the Ping 504 sent in response. Thus, the vehicles that received the initial Beacon 1004 and answered it with some delayed response messages will not be able to receive the Final message and misinterpret it. After reception of the Final message, the VA can calculate the DS-TWR distance, and it can compare its distances and angles of arrival with values received from the GA.

After confirmation that all values are consistent and the VA is really in a continuous ranging zone, the VA sends a confirmation message with Final UWB radio settings, a selected DS-TWR sequence scheme including time scheduling, a selected preamble code, collected time stamps, the calculated SS-TWR distance, and the GA angle of arrival.

In parallel, the VA will establish Wi-Fi communication, as the Wi-Fi settings are already known. From here on the VA and GA are paired and remain in continuous ranging until the positioning is finished or the pairing zone plus hysteresis threshold is exceeded. The continuous ranging is coded with a Master-Key randomly generated from the GA (sent in Poll messages) and Session-Key randomly generated by the VA (sent in Response-Messages). If the VA has left the paired condition, the VA and GA are freed up and execute again the initial pairing procedure starting with default settings.

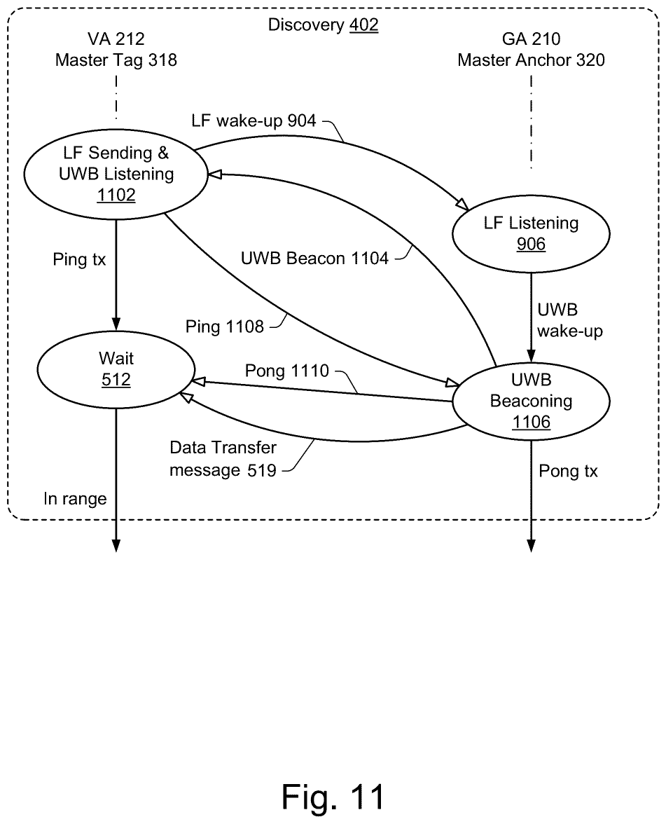

To further increase the MTBF of ground-based UWB transceivers, the methods illustrated in FIGS. 9 and 10A may be combined in a process that is illustrated by FIG. 11. This process includes a new state referred to as LF Sending & UWB Listening 1102. In the LF Sending & UWB Listening state 1102, the Master Tag 318 of an approaching vehicle transmits an LF Wake-up signal 904 while listening for a UWB Beacon 1104 (e.g., Beacon 1004) transmitted by the Master Anchor 320 in a low duty cycle mode (e.g., UWB Beaconing state 1106, Beaconing state 1002). The Master Anchor 320 sends the UWB Beacon 1104 periodically and also in response to receiving the LF wake-up signal 904. Upon reception of the UWB Beacon 1104, the Master Tag 318 responds with a Ping 1108 (e.g., Ping 504) and the subsequent process follows according to FIGS. 5A to 5D. For example, the Master Anchor 320 responds with a Pong 1110 (e.g., Pong 508) upon reception of the Ping 1108 from the Master Tag 318. In some implementations, the Master Anchor 320 also sends the Data Transfer message 519. The VA may stop transmitting the LF Wake-up signal 904 either directly upon reception of the UWB Beacon 1104 or later when the PD session has terminated and the vehicle is in the parking position for charging.

In some implementations, the LF Wake-up signal 904 is modulated (e.g., conveying an ID of the vehicle). Further, the LF magnetic field as generated by the vehicle may be horizontally polarized, for example, in an x-direction, the driving direction of the vehicle. In some implementations, the LF magnetic field is generated in the VA and received in the GA by a solenoid coil wound around a WPT Litz wire coil including a ferrite structure of the VA pad. In other implementations, the LF magnetic field is generated by a multi-coil (e.g., configured as a figure-8 coil also known as a DD coil). These coils may be integrated beneath the ferrite structure (e.g., between the ferrite structure and the WPT Litz wire coil of the VA pad and the GA pad, respectively).

In further implementations, the GA is configured to use the LF Wake-up signal 904 in conjunction with the UWB signals for PD and particularly for determining guidance information when the vehicle is approaching. The LF Wake-up signal 904 may be used for determining a distance and an angle of direction of the magnetic field vector, requiring the GA to be equipped with a 2-axis LF coil system configured to sense the LF magnetic field in two orthogonal directions (e.g., x- and y-direction). The distance and the angle of direction may be used to enhance the UWB-based PD, including determining a rotation angle of the vehicle relative to the GA. In implementations using dynamic filtering of PD data (using Kalman filtering or the like), the distance and the angle of direction as determined from the LF wake-up signal 904 may help to stabilize PD data (e.g., to reduce data scattering caused by multi-path effects in UWB signal propagation).

In additional implementations to further increase the MTBF of ground-based UWB transceivers, the UWB Master Anchor is only woken up if the distance and the angle of direction as determined from the LF wake-up signal 904 are within certain ranges.

### Increasing the MTBF of Vehicle-Onboard UWB Transceivers

As mentioned above, measures to save operating time and therefore to increase MTBF may also be needed for the vehicle-onboard UWB transceivers. For an approaching vehicle to timely discover a GA, the Master Tag 318 must be in the receive mode (RX) (e.g., UWB Listening as part of the state 902) most of the time as illustrated in FIG. 9.

In some implementations, the operating time of the vehicle-onboard UWB transceivers (Tags) is reduced by activating the Master Tag 318 for LF Sending & UWB Listening 902 by driver intervention (e.g., when the driver identifies the parking space intended for charging). Activation may be performed manually (e.g., by pressing a button) or using voice control. In the case of an autonomously driven vehicle, the Master Tag 318 may be activated by an ADS after the parking space is visually identified by onboard cameras or other sensors of the ADS.

In certain implementations or environmental conditions, a charging station may not be easily and reliably identified (e.g., a snow-covered flush mount GA pad), either by a human driver or by an ADS. Moreover, a manual intervention during approach may be forgotten or not timely executed. The need for driver intervention may also be considered impractical, compromising the charging experience, and incompatible with unconscious charging.

In another implementation, the Master Tag 318 is activated for Listening 906 upon detection of a WAP with a specific SSID. This SSID may be associated with the parking space intended for charging. Various cases were mentioned above in which the SSID of the network may be known or assigned outside of the WPT charging process. Assuming the SSID is unique, this solution can substantially reduce the operating time of vehicle-onboard UWB transceivers. However, in a system where the driver or the ADS is free to select any available parking space equipped with wireless charging, the vehicle may not know the SSID in advance. In this case, there may be no option other than to wake up the Master Tag 318 for Listening 906 upon reception of any SSID associated with wireless charging as previously described. Every time the vehicle gets into coverage of a wireless charging Wi-Fi network, the Master Tag will be activated, resulting in many false activations and undesired operating time of the vehicle-onboard UWB transceivers.

In a further implementation, the Master Tag 318 is activated for Listening 906 if the vehicle speed (e.g., as sensed by wheel sensors) is below a certain threshold (e.g., the maximum speed in approach).

In yet another implementation, the Master Tag 318 is activated for Listening 906 if the vehicle speed is below the threshold and upon detection of the wireless charging Wi-Fi network.

It may be appreciated that even combining driving below the speed threshold and Wi-Fi network detection may not suffice to reduce the operating time of vehicle-onboard UWB transceivers. Therefore, in some implementations and for purposes of waking up the Master Tag 318, UWB Beaconing as in FIG. 10 is extended with an LF beacon signal transmitted by the GA. In some implementations, this LF beacon signal is transmitted additionally to the UWB beacon 1104 by all GAs that are available for parking and charging. To receive the LF beacon signal, the vehicle is equipped with a corresponding LF receiver that may be an integral part of the VA. Because of the magnetic near field property and as previously explained, LF beaconing can provide a well-defined range (e.g., 5 m from a GA pad) and thus a more restricted activation of the Master Tag 318 for Listening 906. Moreover, the MTBF of an LF transmitter and LF receiver as used in the GA and aboard the vehicle, respectively, may be orders of magnitude larger than that of a UWB transceiver, thus not requiring a tight activity control. Nevertheless, in some implementations, the vehicle-onboard LF receiver may be controlled at least by the vehicle speed and by prior W-Fi network detection as previously discussed (e.g., for purposes of reducing a false detection rate of an LF beacon signal, which may decrease by limiting the LF receiver's operating time).

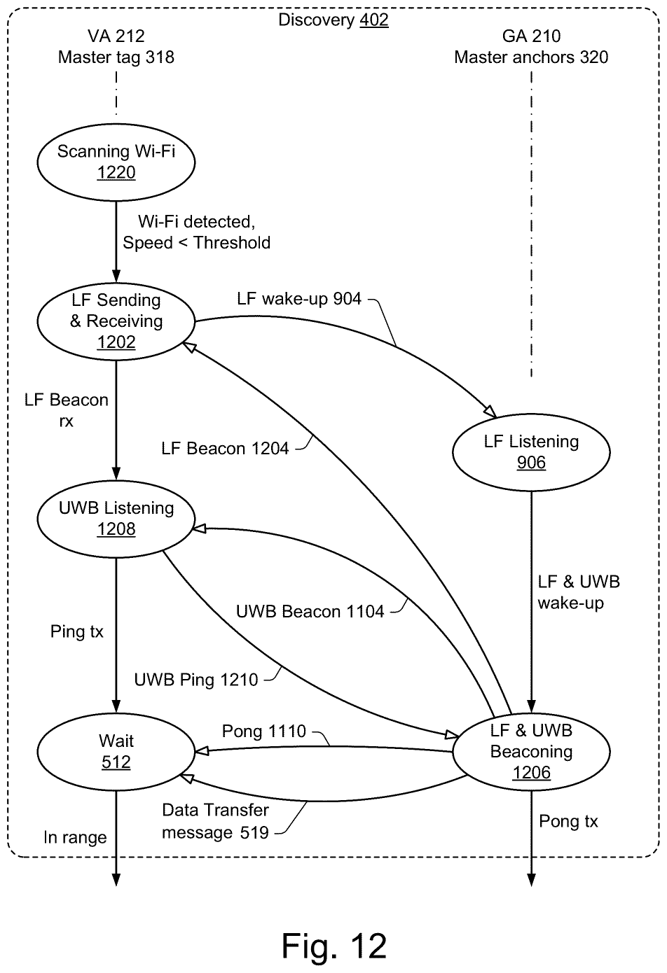

In an example implementation illustrated in FIG. 12, Discovery 402 includes LF & UWB Beaconing 1206 on the GA side. In this state, an LF Beacon 1204 signal is transmitted concurrently with the UWB beacon 1104 signal with reference to FIG. 10A. On the VA side, LF Sending & Receiving 1202 (e.g., LF Sending & Receiving state 1202) may be activated upon detection of a wireless charging Wi-Fi network in a Scanning W-Fi state 1220. Upon reception of the LF Beacon 1204 while in the LF Sending & Receiving state 1202, the VA activates the UWB Master Tag 318 for receiving the UWB Beacon 1104, as illustrated by the transition into a UWB Listening state 1208, and transmission of the LF Wake-up signal 904 is ceased. Upon reception of the UWB Beacon 1104, the Master Tag 318 sends a UWB Ping 1210 (e.g., UWB Ping, 908, Ping 504) to the Master Anchor 320. Upon reception of the UWB Ping 1210, the GA stops transmitting the UWB Beacon 1104 and replies with Pong 508. From this point onwards, the process may follow the process as described with reference to FIGS. 5A to 5D. The GA may stop transmitting the LF Beacon 1204 either directly upon reception of the UWB Ping 1210 or later when the PD session has terminated and the vehicle is in the parking position for charging.

In some implementations, GAs use a common frequency assigned (e.g., in the range from 110 to 145 kHz for sending the LF Beacon 1204). LF receivers in the LF Sending & Receiving state 1202 are tuned to this frequency. In some implementations, GAs use a frequency from a set of defined frequencies based on a frequency assignment. In some implementations, the LF Beacon 1204 frequency is assigned by the vehicle using the modulated LF wake-up signal 904 conveying a frequency channel number. This channel number may be randomly selected by the vehicle from the set of frequencies, avoiding those frequencies that are already in use by some GAs in range. In some implementations, the LF receiver listens on all frequencies of the set of frequencies using an LF receiver bank to receive the expected LF Beacon 1204 on the assigned frequency and to monitor frequency occupation on all other frequencies.

Further, in some implementations, the LF Beacon 1204 signal is modulated with an ID that can be associated with the corresponding UWB beacon 1104 signal as transmitted by the same GA.

The LF magnetic field as generated by the GA may be horizontally polarized, for example, in an x-direction, which is in the direction of the longitudinal axis of the parking space. In some implementations, the LF magnetic field is generated in the GA or received in the VA by a solenoid coil wound around a WPT Litz wire coil including a ferrite structure of the VA pad. In other implementations, the LF magnetic field is generated in the GA or received in the VA by a multi-coil (e.g., configured as a figure-8 coil, also known as a DD coil). These coils may be integrated beneath the ferrite structure (e.g., between the ferrite structure and the WPT Litz wire coil of the GA pad and the VA pad, respectively).

In further implementations, the VA is configured to use the LF Beacon 1204 signal in conjunction with the UWB signals for PD and particularly for determining guidance information when the vehicle is approaching. The LF Beacon 1204 signal may be used for determining a distance and an angle of direction of the magnetic field vector, requiring the VA to be equipped with a 2-axis LF coil system configured to sense the LF magnetic field in two orthogonal directions (e.g., x- and y-direction). The distance and the angle of direction may help to enhance the UWB-based PD, including determining a rotation angle of the GA relative to the vehicle. In implementations using dynamic filtering of PD data (using Kalman filtering or the like), the distance and the angle of direction as determined by the LF Beacon 1204 may help to stabilize PD data (e.g., to reduce data scattering caused by multi-path effects in UWB signal propagation).

In further implementations, the LF Beacon 1204 is transmitted continuously without activation by the LF wake-up signal 904.

In another implementation to further increase the MTBF of ground-based UWB transceivers, the UWB Master Anchor is activated if the distance and the angle of direction as determined from the LF wake-up signal 904 are in certain ranges.

In a further implementation and with reference to FIG. 4, the process of Pairing 406 of a VA with a GA (disambiguation of GAs) is based on the distance between a Master Tag and Master Anchor as determined in SSRS 404. In yet another implementation, Pairing 406 relies at least in part on an angle of arrival (AoA) of the UWB beacon 1104 signal as determined by the VA using one or more of its Tags 204a to 204d. For the AoA, the tags may be operated in a time-synchronized mode requiring a common time reference. In yet a further implementation and with reference to FIGS. 9 to 12, Pairing 406 relies at least in part on a distance and an angle of rotation as determined based on at least one of the LF wake-up signal 904 and the LF beacon 1204.

The various illustrative logical blocks, modules, circuits, and method steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the described aspects.

The various illustrative blocks, modules, and circuits described in connection with the aspects disclosed herein may be implemented or performed with a general-purpose hardware processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose hardware processor may be a microprocessor, but in the alternative, the hardware processor may be any conventional processor, controller, microcontroller, or state machine. A hardware processor may also be implemented as a combination of computing devices (e.g., a combination of a DSP and a microprocessor, a plurality of microprocessors, one or more microprocessors in conjunction with a DSP core, or any other such configuration).

The steps of a method and functions described in connection with the aspects disclosed herein may be embodied directly in hardware, in a software module executed by a hardware processor, or in a combination of the two. If implemented in software, the functions may be stored on or transmitted as one or more instructions or code on a tangible, non-transitory, computer-readable medium. A software module may reside in random access memory (RAM), flash memory, read-only memory (ROM), electrically programmable ROM (EPROM), electrically erasable programmable ROM (EEPROM), registers, a hard disk, a removable disk, a compact disc read-only memory (CD-ROM), or any other form of storage medium known in the art. A storage medium is coupled to the hardware processor such that the hardware processor can read information from, and write information to, the storage medium. In another example, the storage medium may be integral to the hardware processor. Disk and disc, as used herein, include compact disc (CD), laser disc, optical disc, digital versatile disc (DVD), floppy disk, and Blu-Ray™ disc, where disks usually reproduce data magnetically while discs reproduce data optically with lasers. Combinations of the above should also be included within the scope of computer-readable media. The hardware processor and the storage medium may reside in an ASIC.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

Although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed. For example, the context of the above description is wireless charging of electric vehicles, but these techniques may be used in other situations where a portable device needs to join a wireless network corresponding to a specific hardware component located in proximity to the wireless device, and multiple such components or networks may be present.

A number of implementations have been described. Nevertheless, it will be understood that additional modifications may be made without departing from the scope of the concepts described herein, and, accordingly, other embodiments are within the scope of the following claims.

What is claimed is:

1. A method for pairing a vehicle having a plurality of ultra-wideband (UWB) tags to a wireless power transfer (WPT) station having a first plurality of UWB anchors, the method comprising:
at a Master Tag of the plurality of UWB tags, transmitting a first Ping message;
at a Master Anchor of the first plurality of UWB anchors, receiving the first Ping message and transmitting a first Pong message;
at the Master Tag, receiving the first Pong message;
at the Master Tag, transmitting a first Poll message;
at the Master Anchor, receiving the first Poll message and transmitting a first Response message;
based on the first Response message, determining a distance between the Master Tag and the Master Anchor; and
communicating setup parameters between the Master Tag and the Master Anchor to establish ongoing communications between the vehicle and the WPT station.

2. The method of claim 1, wherein the setup parameters comprise a sync-code randomly selected from a list of existing sync-codes by the Master Tag.

3. The method of claim 1, wherein the setup parameters comprise a station-to-station (STS)-Key generated by the Master Anchor.

4. The method of claim 1, wherein the Master Anchor transmits the first Pong message at a randomly determined time slot.

5. The method of claim 1, wherein the first Poll message and the first Response message are used to determine the distance using a single-sided two-way ranging (SS-TWR) process.

6. The method of claim 1, wherein the first Poll message and the first Response message are used to determine the distance using a double-sided two-way ranging (DS-TWR) process.

7. The method of claim 1, further comprising:
continuously determining an updated relative position between the vehicle and the WPT station.

8. The method of claim 7, wherein:
the setup parameters include information describing a position of each UWB anchor within the WPT station; and
continuously determining the updated relative position comprises:
interleaving double-sided two-way ranging (DS-TWR) messages between each UWB tag of the plurality of tags and each UWB anchor within the station;
based on the DS-TWR messages, determining the distance between each UWB tag and each UWB anchor; and
based on the determined distances between the UWB tags and the UWB anchors and the position of each UWB anchor within the WPT station, determining the relative position of the vehicle with respect to the WPT station.

9. The method of claim 1, wherein:
establishing ongoing communications between the vehicle and the WPT station comprises joining a Wi-Fi transceiver of the vehicle to a Wi-Fi network with which the WPT station is also in communication.

10. The method of claim 1, wherein:
establishing ongoing communications between the vehicle and the WPT station comprises establishing a persistent data connection between the plurality of UWB tags and the first plurality of UWB anchors.

11. The method of claim 1, further comprising:
at a second Master Anchor of a second plurality of UWB anchors at a second WPT station, receiving the first Ping message and transmitting a second Pong message;
at the Master Tag, receiving the second Pong message;
at the Master Tag, transmitting a second Poll message;
at the second Master Anchor, receiving the second Poll message and transmitting a second Response message; and
based on the first Response message and the second Response message, selecting whichever of the first and second WPT stations is closer to the vehicle,
wherein communicating setup parameters between the Master Tag and the Master Anchor comprises communicating the setup parameters between the Master Tag and a corresponding Master Anchor of the selected WPT station to establish ongoing communications between the vehicle and the selected WPT station.

12. A method for pairing a vehicle having a plurality of ultra-wideband (UWB) tags to a wireless power transfer (WPT) station having a first plurality of UWB anchors, the method comprising:
at a Master Tag of the plurality of UWB tags:
transmitting a first Ping message;
receiving a first Pong message and determining that the first Pong message was transmitted by a Master Anchor of the first plurality of UWB anchors; and
transmitting a first Poll message and receiving a first Response message from the Master Anchor;
at the vehicle, based on the first Response message, determining a distance between the Master Tag and the Master Anchor; and
at the Master Tag, exchanging setup parameters with the Master Anchor to establish ongoing communications between the vehicle and the WPT station.

13. A method for pairing a vehicle having a plurality of ultra-wideband (UWB) tags to a wireless power transfer (WPT) station having a first plurality of UWB anchors, the method comprising:
at a Master Anchor of the plurality of UWB anchors:
receiving a first Ping message from a Master Tag of the plurality of UWB tags;
transmitting a first Pong message;
receiving a first Poll message from the Master Tag;
transmitting a first Response message; and
exchanging setup parameters with the Master Tag to establish ongoing communications between the vehicle and the WPT station.

14. A system, comprising:
a vehicle having a wireless power transfer (WPT) system and a plurality of ultra-wideband (UWB) tags, the plurality of UWB tags comprising a Master Tag;
a WPT station having a first plurality of UWB anchors, the plurality of UWB tags comprising a Master Anchor;
a first processor in the vehicle, configured to cause the Master Tag to transmit a first Ping message, receive a first Pong message in response to the first Ping message, transmit a first Poll message, and receive a first Response message in response to the first Poll message; and
a second processor in the WPT station, configured to cause the Master Anchor to transmit the first Pong message in response to receiving the first Ping message, and transmit the first Response message in response to receiving the first Poll message,
wherein the first processor is further configured to:
in response to the Master Tag receiving the first Response message, determine a distance between the Master Tag and the Master Anchor based on the first Response message; and
use the Master Tag to exchange setup parameters with the Master Anchor to establish ongoing communications between the vehicle and the WPT station.

15. A wireless power transfer (WPT) system for use in a vehicle, comprising:
a plurality of ultra-wideband (UWB) tags, the plurality of UWB tags comprising a Master Tag; and
a processor, configured to:
cause the Master Tag to transmit a first Ping message and receive Pong messages;
in response to each Pong message received by the Master Tag, determine whether the Pong message was transmitted by a Master Anchor associated with a WPT station in response to the first Ping message;
in response to a determination that a selected ranging echo was transmitted by the Master Anchor in response to the first Ping message, use single-sided two-way ranging (SS-TWR) or double-sided two-way ranging (DS-TWR) to determine a distance between the Master Tag and the Master Anchor that transmitted the selected ranging echo, the distance determined based on the selected ranging echo; and
in response to a determination that a selected Master Anchor is within a threshold distance of the Master Tag, use the Master Tag to exchange setup parameters with the selected Master Anchor to establish ongoing communications between the vehicle and the WPT station associated with the selected Master Anchor.

16. A wireless power transfer (WPT) station for use with a vehicle having a WPT system, the WPT station comprising:
a plurality of ultra-wideband (UWB) anchors, the plurality of UWB anchors comprising a Master Anchor; and
a processor configured to:
cause the Master Anchor to transmit a Pong message in response to receiving a first Ping message from a Master Tag associated with the vehicle;
cause the Master Anchor to participate in single-sided two-way ranging (SS-TWR) or double-sided two-way ranging (DS-TWR) with the Master Tag; and
use the Master Anchor to exchange setup parameters with the Master Tag to establish ongoing communications between the WPT station and the vehicle associated with the Master Tag.
